(19) United States
(12) Patent Application Publication
(10) Pub. No.: US 2007/0042655 A1
(43) Pub. Date: Feb. 22, 2007

(54) Natural polymer mat and manufacturing method thereof

(76) Inventor: Hsu Tang Su-Tuan, Tao Yuan City (TW)

Correspondence Address: TROXELL LAW OFFICE PLLC, SUITE 1404, 5205 LEESBURG PIKE, FALLS CHURCH, VA, 22041, US

(21) Appl. No.: 11/205,090

(22) Filed: Aug. 17, 2005

(51) Int. Cl. B32B 27/04; B32B 27/12

(52) U.S. Cl. 442/43; 442/58; 427/374.1; 427/355

(57) ABSTRACT

A natural polymer mat, which is biodegradable, and manufacturing method thereof are disclosed. The present method includes the steps of: (a) providing, flattening and conveying a piece of meshed cloth; (b) coating the flattened meshed cloth with natural high polymer raw material regulated according to a predetermined formula contained in a cotainer; (c) drying the natural high polymer raw material at a predetermined high temperature; and (d) rapidly cooling down to consolidate the natural high polymer material. The formula for regulating the natural high polymer raw material includes a large percentage of natural high polymer raw material, a tiny percentage of yeast, a small percentage of pure water, resin and crosslinking agent.

### BACKGROUND OF THE INVENTION

1. Field of the Invention

The present invention relates to a natural polymer mat and manufacturing method thereof, and more particularly, to a mat made by natural polymer as stuff, which is biodegradable by the microorganism in the soil, rather than traditional plastic.

2. Description of the Prior Art

Although industrialized society brings the people with convenient lifestyle, the accompanying problem is the excessive use of plastic products made from petroleum. Plastic products are hard to be decomposed and thus cause environmental pollution. The poll conducted by Gallop indicates that in 2002 the disposed plastic trash accounts for 9.8% in the solid trash amounting to 2.16 hundred million in America, and even 15% in Taiwan.

At present, it is inevitable to use polluting plastic, such as polyvinyl chloride (PVC), in the technology for manufacturing anti-slide mats or exercise mats. Therefore, there is a need to develop a novel mat without using plastic and keep the desired characteristics of plastic.

### SUMMARY OF THE INVENTION

The present invention provides a natural polymer mat and the manufacturing method thereof, which uses natural polymer material as the stuff to replace plastic. The present natural polymer mat is environmental-friendly and still keeps the desired characteristics of plastic.

The present invention discloses a method for manufacturing a natural polymer mat, which is biodegradable. The present method includes the steps of: (a) providing, flattening and conveying a piece of meshed cloth; (b) coating the flattened meshed cloth with natural high polymer raw material regulated according to a predetermined formula contained in a container; (c) drying the natural high polymer raw material at a predetermined high temperature; and (d) rapidly cooling down to consolidate the natural high polymer material.

The present invention discloses a natural polymer mat, including a piece of meshed cloth, having an upper surface and a lower surface, and a natural polymer material layer, coated on the upper surface and the lower surface. The formula for regulating the natural polymer material layer includes a large percentage of natural high polymer raw material, a tiny percentage of yeast, a small percentage of pure water, resin and crosslinking agent

### BRIEF DESCRIPTION OF THE DRAWINGS

The foregoing aspects and many of the attendant advantages of this invention will become more readily appreciated and better understood by referencing the following detailed description, when taken in conjunction with the accompanying, wherein:

FIG. 1 illustrates the method of forming the present natural polymer mat according to the present invention;

FIG. 2 illustrates the perspective view of the present natural polymer mat according to the present invention; and

FIG. 3 illustrates the flow chart of forming the natural polymer raw material according to the present invention.

### DESCRIPTION OF THE PREFERRED EMBODIMENT

The present invention discloses a natural polymer mat and manufacturing method thereof. A piece of meshed cloth, which servers as a substrate, is provided. The meshed cloth is coated with natural polymer raw material, pressed, dried, rapidly cooled down and consolidated.

However, the commonly used high polymer materials, such as amylum or cellulose, have no satisfying plasticity as plastic. Meanwhile, compared with plastic, it is hard to properly control their physical characteristic. Therefore, conversion of physical property and precise control of manufacturing process are required to manufacture the present natural polymer mat, such as anti-slide mats or exercise mats.

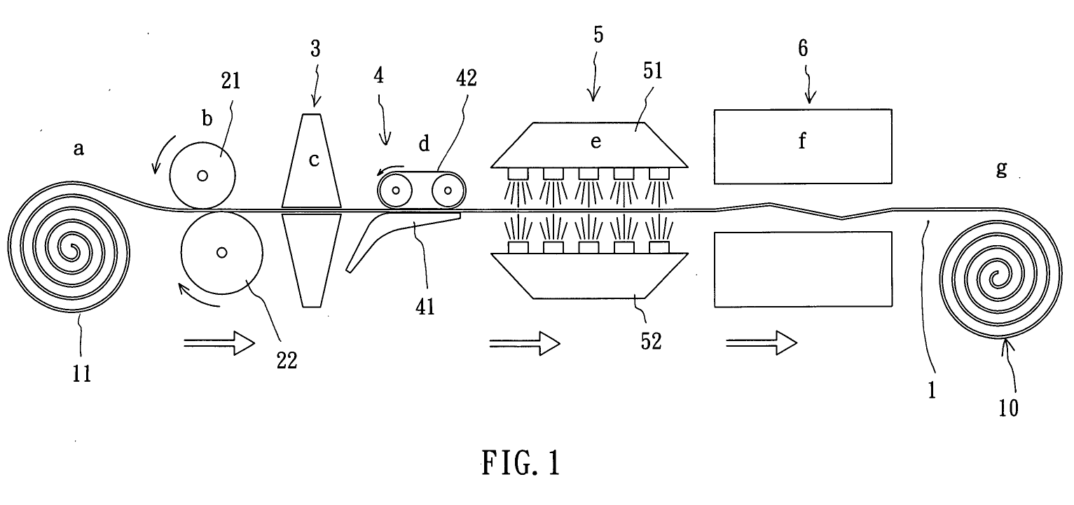

Please refer to FIG. 1, which depicts the method for manufacturing the present natural polymer mat 1. (a) First, a piece of meshed cloth 11 is provided, flattened and conveyed. (b) At least two rollers 21 and 22, rotating in opposite directions, are provided and arranged on different levels. The meshed cloth 11 passes through the region between the rollers 21 and 22, and leans against the rollers 21 and 22 so that the meshed cloth 11 is flattened. (c) The flattened meshed cloth 11 is coated with natural high polymer material, regulated according to a predetermined formula, contained in a container 3 located above the two surfaces of the meshed cloth 11. (d) The semi-finished meshed cloth 11 coated with natural high polymer material is pressed by a roller presser module 4 to further flatten the meshed cloth. The roller presser module 4 includes a plate 41 and a transmission belt 42 leaning against the plate 41. The semi-finished meshed cloth 11 is conveyed and sandwiched between the plate 41 and the transmission belt 42. (e) A heater module 5, including an upper heater 51 and a lower heater 52, is provided to dry the upper and lower surfaces of the natural high polymer material, respectively, at a pre-determined high temperature. The upper heater 51 and a lower heater 52 can be lamps and the pre-determined high temperature can be 220 degree Celsius. (f) A cooling area 6 is provided to cool down, at a pre-determined low temperature, to consolidate the natural high polymer material and thus finish the natural high polymer mat 1. The pre-determined low temperature can be 5 degree Celsius. (g) The natural high polymer mat 1 is rolled up to obtain a roll-type natural high polymer mat 10.

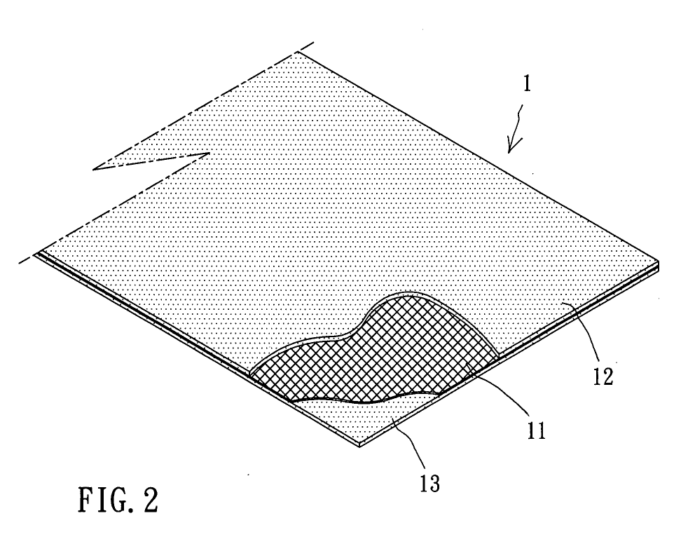

As shown in FIG. 2, the natural high polymer mat 1 includes meshed cloth 11 having an upper surface and a lower surface coated with a natural high polymer layer 12 and a natural high polymer layer 13, respectively. The natural polymer layers 12 and 13 are regulated according to a pre-determined formula consisting of a large percentage of natural polymer, a tiny percentage of yeast, a small percentage of pure water, a small amount of resin and a small amount of crosslinking agent.

The method for forming the formula of the natural polymer mat 1 includes the following steps. First, in step S1, the large percentage of natural polymer material (about 70%), such as amylum, the tiny percentage of yeast (about 1%) and the small percentage of pure water (about 20%) are mixed. Then, in step S4, the small percentage of resin (about 5%) is added into the mixture of natural polymer material, amylum, yeast and pure water. Thereafter, in step S5, the small percentage of crosslinking agent (about 4%) is added the mixture of natural polymer material, amylum, yeast, pure water as well as resin, and then further mixed properly.

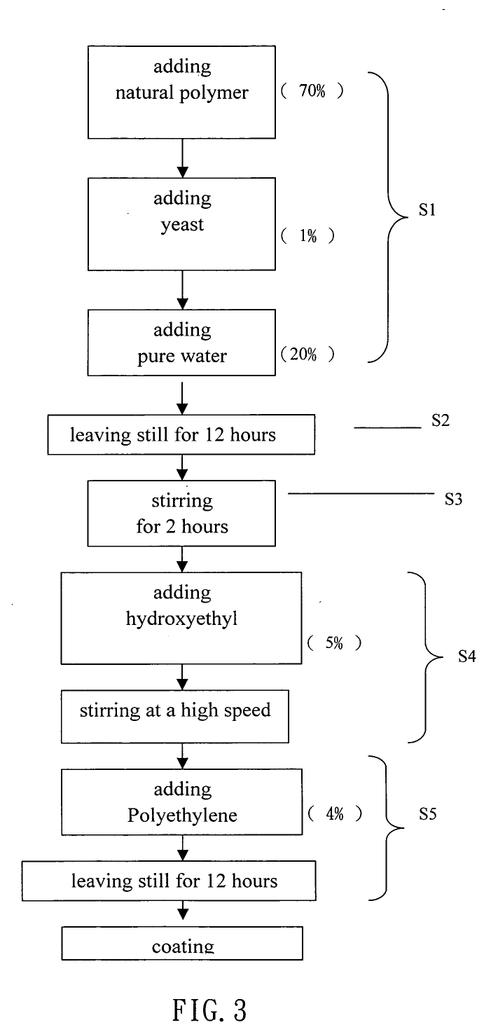

Please refer to FIG. 3, which depicts the flowchart of regulating the formula. In step 1, the large percentage of natural polymer, the tiny percentage of yeast and the small percentage of pure water are arranged in order. In step S2, the above materials are left still for about 12 hours to quench or ferment. In step S3, the above materials are stirred and mixed, in a high speed, for about 2 hours using a single-screw extruder. In step S4, the small percentage of resin, such as hydroxyethyl, is added and further mixed in a high speed. In step S5, the small percentage of crosslinking agent, such as polyethylene, is added and then left still for about 12 hours so as to obtain the natural polymer raw material.

In sum, the natural polymer mat and the manufacturing method thereof of the present invention include the following advantages. First, although the present natural polymer mat is made of natural polymer material, such as amylum or cellulose, as stuff, the present natural polymer mat retains the same functions that the plastic mat provides. Second, because the present mat uses natural polymer material as stuff, instead of plastic, the present mat does not discomfort the human skin. Third, because the present mat uses natural polymer material as stuff, the present mat can be decomposed by microorganisms after disposal and become inorganic matters, such as carbon dioxide or water and be fully absorbed by the environment.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A method for manufacturing a natural polymer mat, comprising the steps as follows:
providing, flattening and conveying a piece of meshed cloth;
coating the flattened meshed cloth with natural polymer raw material, regulated according to a pre-determined formula, contained in a container;
drying the natural polymer raw material at a predetermined high temperature; and
cooling down the natural polymer raw material so as to consolidate the natural polymer raw material and obtain the natural polymer mat;
wherein the formula includes natural polymer material, yeast, pure water, resin and crosslinking agent.

2. The method according to claim 1, wherein the step of flattening the meshed cloth further comprises:
providing two rollers, which the meshed cloth passes through and leans against, so as to flatten the meshed cloth.

3. The method according to claim 1, wherein the step of flattening the meshed cloth further comprises: providing a roller presser module to further flatten the meshed cloth coated with the natural polymer raw material.

4. The method according to claim 1, wherein the formula is regulated according to the following steps, comprising:
arranging the natural polymer, the yeast and the pure water in order;
leaving the natural polymer, the yeast and the pure water still for about a first period of time so as to quench or ferment;
adding the resin after the natural polymer, the yeast and the pure water are mixed for a second period of time;
adding the crosslinking agent after the natural polymer, the yeast, the pure water and the resin are mixed.

5. The method according to claim 4, wherein the first period of time and the second period of time are 12 hours and 2 hours, respectively; and wherein the crosslinking agent, the natural polymer, the yeast, the pure water and the resin are mixed in a high speed using a single-screw extruder.

6. The method according to claim 1, wherein the step of drying the natural polymer raw material further comprises:
drying the natural polymer raw material at the temperature of about 220 degree Celsius.

7. The method according to claim 1, wherein the step of cooling down the natural polymer raw material further comprises:
consolidating the natural polymer raw material at the temperature of about 5 degree Celsius.

8. The method according to claim 1, wherein after the step of cooling down the natural polymer raw material further comprises:
rolling up the natural polymer so as to obtain a roll-type natural polymer.

9. The method according to claim 1, wherein the natural polymer material is amylum.

10. The method according to claim 1, wherein the resin is hydroxyethyl.

11. The method according to claim 1, wherein the crosslinking agent is polyethylene.

12. The method according to claim 1, wherein the natural polymer raw material accounts for 70%, the yeast accounts for 1%, the pure water accounts for 20% and the resin accounts for 5%.

13. A natural polymer mat, comprising:
a piece of meshed cloth, having an upper surface and a lower surface; and
a natural polymer material layer, coated on the upper surface and the lower surface;
wherein the formula includes natural polymer material, yeast, pure water, resin and crosslinking agent.
